(19) United States
(12) Patent Application Publication
(10) Pub. No.: US 2017/0091811 A1
(43) Pub. Date: Mar. 30, 2017

(54) SYSTEMS, METHODS, AND DEVICES FOR CUSTOMIZED DATA EVENT ATTRIBUTION AND BID DETERMINATION

(71) Applicant: Turn Inc., Redwood City, CA (US)

(72) Inventors: Abhishek Saxena, Cupertino, CA (US); Ali Dasdan, San Jose, CA (US); Sam Boosalis, Redwood City, CA (US)

(73) Assignee: Turn Inc., Redwood City, CA (US)

(21) Appl. No.: 14/864,041

(22) Filed: Sep. 24, 2015

(51) Int. Cl. G06Q 30/02

(52) U.S. Cl. CPC G06Q 30/0247; G06Q 30/0277

(57) ABSTRACT

Disclosed herein are systems, methods, and devices for generating attribution metrics. Systems include a sequential data structure generator configured to generate sequential data structures based on performance data. Each of the sequential data structures characterizes a sequential representation of at least some of a plurality of data events during a first time period. Systems also include an attribution metric generator configured to generate a first plurality of attribution scores and a first plurality of attribution metrics based on a first plurality of dimensions associated with the plurality of data events included in the sequential data structures. Systems further include a resource file generator configured to generate a first resource file that stores data values characterizing the first plurality of attribution metrics. The first resource file is capable of being provided to an advertisement server and being used to generate at least one message including a bid request.

### TECHNICAL FIELD

This disclosure generally relates to online advertising, and more specifically to data event attribution and bid determination associated with online advertising.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

### SUMMARY

Disclosed herein are systems, methods, and devices for generating attribution metrics. In various embodiments, the systems may include a sequential data structure generator configured to generate a plurality of sequential data structures based on performance data, where the performance data characterizes a plurality of data events associated with a plurality of interactions between at least one user and at least one online advertisement entity. In some embodiments, each of the plurality of sequential data structures characterizes a sequential representation of at least some of the plurality of data events during a first time period. The systems may also include an attribution metric generator configured to generate a first plurality of attribution scores and a first plurality of attribution metrics based on a first plurality of dimensions associated with the plurality of data events included in the plurality of sequential data structures, where each of the first plurality of attribution scores identifies a portion of a data event that is attributed to an action, and where each of the first plurality of attribution metrics identifies a number of actions attributed to the at least one online advertisement entity. In some embodiments, each of the first plurality of attribution metrics is generated based on multiple attribution scores included in each sequential data structure that resulted in an action associated with the at least one online advertisement entity. The systems may further include a resource file generator configured to generate a first resource file configured to store one or more data values characterizing the first plurality of attribution metrics, where the first resource file is capable of being provided to an advertisement server and being used to generate at least one message including a bid request.

In various embodiments, each of the first plurality of dimensions comprises at least one characteristic of at least one data event. In some embodiments, each of the first plurality of dimensions is selected from the group consisting of: a biographical identifier, a top level domain identifier, a geographical identifier, a device identifier, a network identifier, an advertisement identifier, an advertiser identifier, and a data category identifier. In various embodiments, the sequential data structure generator is further configured to generate a second plurality of attribution scores and a second plurality of attribution metrics based, at least in part, on a second plurality of dimensions associated with the plurality of data events. In some embodiments, the resource file generator is further configured to generate a second resource file configured to store one or more data values characterizing the second plurality of attribution metrics.

According to some embodiments, the generating of the first plurality of attribution scores further includes calculating a plurality of normalized probabilistic weights, where the plurality of normalized probabilistic weights are normalized based, at least in part, on the first plurality of dimensions. In some embodiments, each of the first plurality of attribution metrics is associated with one online advertisement entity and characterizes a probability that a data event associated with the online advertisement entity will result in an action. In various embodiments, an online advertisement entity is an entity selected from the group consisting of: an online advertisement campaign and an online advertisement sub-campaign. In some embodiments the attribution metric generator is further configured to generate a third plurality of attribution scores and a third plurality of attribution metrics based on the plurality of sequential data structures, where each of the third plurality of attribution scores identifies a last data event in a sequential data structure that is attributed to an action, and where each of the third plurality of attribution metrics identifies a number of actions attributed to an online advertisement entity. In various embodiments, the first resource file is further configured to store one or more data values characterizing the third plurality of attribution metrics. In some embodiments, a data event is an event selected from the group consisting of: an advertisement view, a page view, and an electronic message, and wherein a user action selected from the group consisting of: a click-through, a purchase, an entry of information in a web-form.

Also disclosed herein are devices that may include a first processing node configured to generate a plurality of sequential data structures based on performance data, where the performance data characterizes a plurality of data events associated with a plurality of interactions between at least one user and at least one online advertisement entity, and where each of the plurality of sequential data structures characterizes a sequential representation of at least some of the plurality of data events during a first time period. The devices may also include a second processing node configured to generate a first plurality of attribution scores and a first plurality of attribution metrics based on a first plurality of dimensions associated with the plurality of data events included in the plurality of sequential data structures, where each of the first plurality of attribution scores identifies a portion of a data event that is attributed to an action, where each of the first plurality of attribution metrics identifies a number of actions attributed to the at least one online advertisement entity, and where each of the first plurality of attribution metrics is generated based on multiple attribution scores included in each sequential data structure that resulted in an action associated with the at least one online advertisement entity. The devices may further include a third processing node configured to generate a first resource file configured to store one or more data values characterizing the first plurality of attribution metrics, where the first resource file is capable of being provided to an advertisement server and being used to generate at least one message including a bid request.

In various embodiments, the first processing node is further configured to generate a second plurality of attribution scores and a second plurality of attribution metrics based, at least in part, on a second plurality of dimensions associated with the plurality of data events. In some embodiments, the third processing node is further configured to generate a second resource file configured to store one or more data values characterizing the second plurality of attribution metrics. In various embodiments, the generating of the first plurality of attribution scores further includes calculating a plurality of normalized probabilistic weights, where the plurality of normalized probabilistic weights are normalized based, at least in part, on the first plurality of dimensions. In some embodiments, each of the first plurality of attribution metrics is associated with one online advertisement entity and characterizes a probability that a data event associated with the online advertisement entity will result in an action. According to various embodiments, the second processing node is further configured to generate a third plurality of attribution scores and a third plurality of attribution metrics based on the plurality of sequential data structures, where each of the third plurality of attribution scores identifies a last data event in a sequential data structure that is attributed to an action, and where each of the third plurality of attribution metrics identifies a number of actions attributed to an online advertisement entity.

Also disclosed herein are one or more non-transitory computer readable media having instructions stored thereon for performing a method, the method including generating a plurality of sequential data structures based on performance data, where the performance data characterizes a plurality of data events associated with a plurality of interactions between at least one user and at least one online advertisement entity, and where each of the plurality of sequential data structures characterizes a sequential representation of at least some of the plurality of data events during a first time period. The methods may also include generating a first plurality of attribution scores based, at least in part, on a first plurality of dimensions associated with the plurality of data events included in the plurality of sequential data structures, where each attribution score identifies a portion of a data event that is attributed to an action. The methods may further include generating a first plurality of attribution metrics based, at least in part, on the first plurality of dimensions associated with plurality of data events included in the plurality of sequential data structures and based on the first plurality of attribution scores, where each of the first plurality of attribution metrics identifies a number of actions attributed to an online advertisement entity, and where each of the first plurality of attribution metrics is generated based on multiple attribution scores included in each sequential data structure that resulted in an action associated with the at least one online advertisement entity. The method may also include generating a first resource file configured to store one or more data values characterizing the first plurality of attribution metrics, where the first resource file is capable of being provided to an advertisement server and being used to generate at least one message including a bid request.

In various embodiments, the methods may also include generating a second plurality of attribution scores and a second plurality of attribution metrics based, at least in part, on a second plurality of dimensions associated with the plurality of data events, and generating a second resource file configured to store one or more data values characterizing the second plurality of attribution metrics. In some embodiments, the generating of the first plurality of attribution scores further includes calculating a plurality of normalized probabilistic weights, the plurality of normalized probabilistic weights being normalized based, at least in part, on the first plurality of dimensions. In various embodiments, the methods may further include generating a third plurality of attribution scores and a third plurality of attribution metrics based on the plurality of sequential data structures, where each of the third plurality of attribution scores identifies a last data event in a sequential data structure that is attributed to an action, and where each of the third plurality of attribution metrics identifies a number of actions attributed to an online advertisement entity.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of an advertiser hierarchy, implemented in accordance with some embodiments.

FIG. 2 illustrates a diagram of an example of a system for generating attribution metrics, implemented in accordance with some embodiments.

FIG. 3 illustrates a flow chart of an example of an attribution metric generation method, implemented in accordance with some embodiments.

FIG. 4 illustrates a flow chart of another example of an attribution metric generation method, implemented in accordance with some embodiments.

FIG. 5 illustrates a flow chart of an example of an attribution adjustment value determination method, implemented in accordance with some embodiments.

FIG. 6 illustrates a flow chart of an example of a performance testing method, implemented in accordance with some embodiments.

FIG. 7A illustrates an example of action attribution, implemented in accordance with some embodiments.

FIG. 7B illustrates another example of action attribution, implemented in accordance with some embodiments.

FIG. 8 illustrates a data processing system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In online advertising, advertisers often try to provide the best ad for a given user in an online context. Advertisers often set constraints which affect the applicability of the advertisements. For example, an advertiser might try to target only users in a particular geographical area or region who may be visiting web pages of particular types for a specific campaign. Thus, an advertiser may try to configure a campaign to target a particular group of end users, which may be referred to herein as an audience. As used herein, a campaign may be an advertisement strategy which may be implemented across one or more channels of communication. Furthermore, the objective of advertisers may be to receive as many user actions as possible by utilizing different campaigns in parallel. As previously discussed, an action may be the purchase of a product, filling out of a form, signing up for e-mails, and/or some other type of action. In some embodiments, actions or user actions may be advertiser-defined and may include an affirmative act performed by a user, such as inquiring about or purchasing a product and/or visiting a certain page.

In various embodiments, an ad from an advertiser may be shown to a user with respect to publisher content, which may be a website or mobile application if the value for the ad impression opportunity is high enough to win in a real-time auction. Advertisers may determine a value associated with an ad impression opportunity by determining a bid. In some embodiments, such a value or bid may be determined based on the probability of receiving an action from a user in a certain online context multiplied by the cost-per-action goal an advertiser wants to achieve. Once an advertiser, or one or more demand-side platforms that act on their behalf, wins the auction, it is responsible to pay the amount that is the winning bid.

In various embodiments, to effectively distribute a budget amongst online advertisement campaigns and sub-campaigns as well as determine values for bid requests submitted by advertisement servers, an advertiser may attempt to identify which sub-campaigns and line items are providing the greatest return, which sub-campaign contributed to how many user actions, hence quantifying the effectiveness of the different targeting parameters utilized in each sub-campaign. As will be discussed in greater detail below, various data event attribution operations may be implemented to determine which campaigns and sub-campaigns contributed to which user actions, and to what extent. In various embodiments, such attribution operations may be customized to a particular campaign or sub-campaign, thus providing an accurate attribution of actions to that campaign or sub-campaign, as well as an accurate representation of a value conferred, or a return-on-investment associated with that campaign.

Accordingly, various systems, methods, and devices disclosed herein provide the generation of attribution metrics associated with online advertisement campaigns as well as the determination of the values of bids based on such attribution metrics. As will be discussed in greater detail below, attribution metrics may characterize a probability that an advertisement campaign or sub-campaign may receive an action from a user. In various embodiments, the generation of attribution metrics disclosed herein may be based on multiple dimensions, which may be features or characteristics, of data events that led to the user actions. As discussed in greater detail below, the implementation of attribution operations based on multiple dimensions of the data events enables a highly customized action attribution that is highly configurable for a particular campaign or sub-campaign and enables a very precise and targeted representation of a performance of the campaign or sub-campaign. Moreover, multiple sets or combinations of dimensions may be analyzed and utilized to generate different sets of attribution metrics as well as different bids determined based on such attribution metrics. Accordingly, various embodiments disclosed herein provide the implementation of multi-dimensional multi-touch attribution operations that may generate attribution scores and metrics based on past performance data. The results of such attribution operations may be provided to advertisement servers and may form the basis of a bid determination calculation performed by the advertisement servers.

In various embodiments, analyzing multiple dimensions of the data events at once reduces a number of times performance data is scanned and accessed, thus reducing overall processing overhead associated with the generation of the attribution metrics as well as bids determined based on the attribution metrics. For example, according to various embodiments, multiple dimensions may be analyzed based on two scans of performance data and/or user profile data. In contrast, conventional techniques may require two scans for each dimension set, thus resulting in numerous additional scans, increased computational demands, and a processing time that may not be feasible in real time.

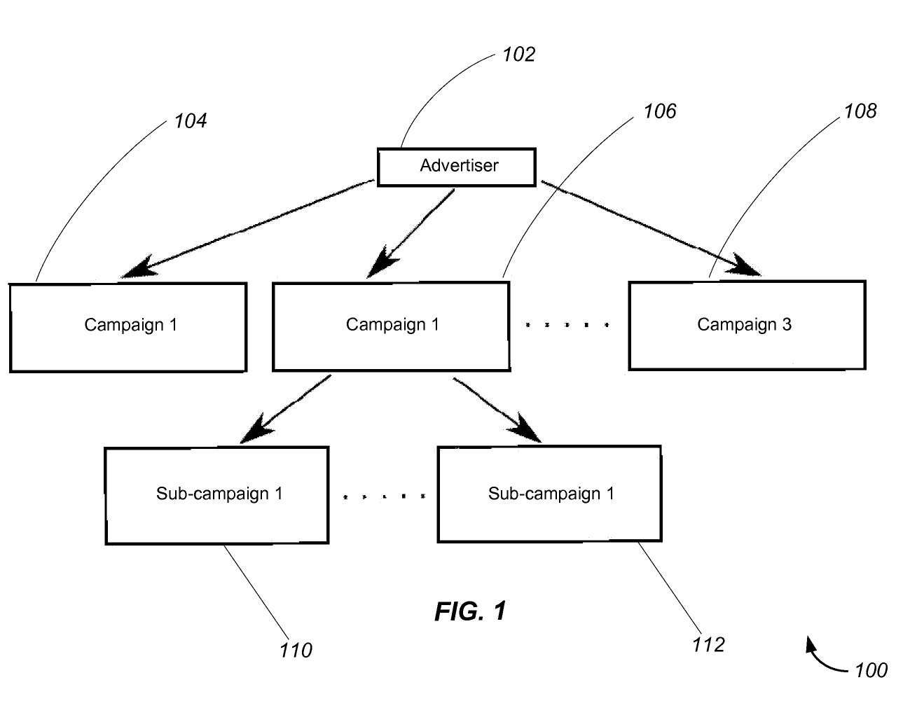

FIG. 1 illustrates an example of an advertiser hierarchy, implemented in accordance with some embodiments. As previously discussed, advertisement servers may be used to implement various advertisement campaigns to target various users or an audience. In the context of online advertising, an advertiser, such as the advertiser 102, may display or provide an advertisement to a user via a publisher, which may be a web site, a mobile application, or other browser or application capable of displaying online advertisements. The advertiser 102 may attempt to achieve the highest number of user actions for a particular amount of money spent, thus, maximizing the return on the amount of money spent. Accordingly, the advertiser 102 may create various different tactics or strategies to target different users. Such different tactics and/or strategies may be implemented as different advertisement campaigns, such as campaign 104, campaign 106, and campaign 108, and/or may be implemented within the same campaign. Each of the campaigns and their associated sub-campaigns may have different targeting rules which may be referred to herein as an audience segment. For example, a sports goods company may decide to set up a campaign, such as campaign 104, to show golf equipment advertisements to users above a certain age or income, while the advertiser may establish another campaign, such as campaign 106, to provide sneaker advertisements towards a wider audience having no age or income restrictions. Thus, advertisers may have different campaigns for different types of products. The campaigns may also be referred to herein as insertion orders.

Each campaign may include multiple different sub-campaigns to implement different targeting strategies within a single advertisement campaign. In some embodiments, the use of different targeting strategies within a campaign may establish a hierarchy within an advertisement campaign. Thus, each campaign may include sub-campaigns which may be for the same product, but may include different targeting criteria and/or may use different communications or media channels. Some examples of channels may be different social networks, streaming video providers, mobile applications, and web sites. For example, the sub-campaign 110 may include one or more targeting rules that configure or direct the sub-campaign 110 towards an age group of 18-34 year old males that use a particular social media network, while the sub-campaign 112 may include one or more targeting rules that configure or direct the sub-campaign 112 towards female users of a particular mobile application. As similarly stated above, the sub-campaigns may also be referred to herein as line items.

Accordingly, an advertiser 102 may have multiple different advertisement campaigns associated with different products. Each of the campaigns may include multiple sub-campaigns or line items that may each have different targeting criteria. Moreover, each campaign may have an associated budget which is distributed amongst the sub-campaigns included within the campaign to provide users or targets with the advertising content.

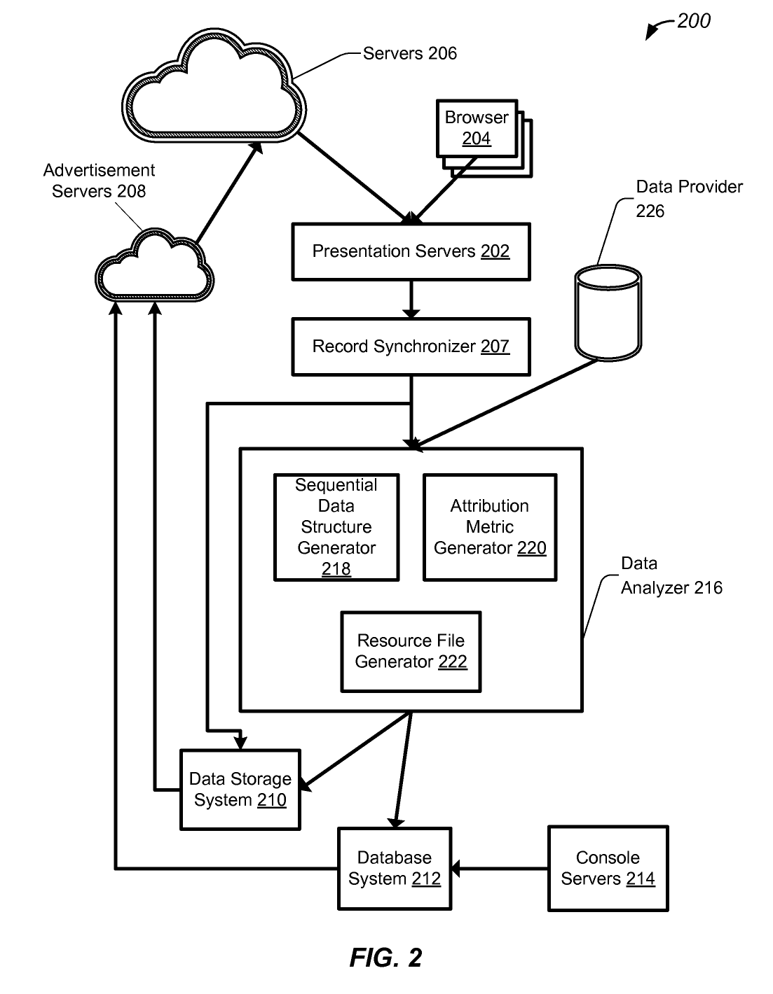

FIG. 2 illustrates a diagram of an example of a system for generating attribution metrics, implemented in accordance with some embodiments. In various embodiments, system 200 may include one or more presentation servers, such as presentation servers 202. According to some embodiments, presentation servers 202 may be configured to aggregate various online advertising data from several data sources. The online advertising data may include live internet data traffic that may be associated with users, as well as variety of supporting tasks. For example, the online advertising data may include one or more data values identifying various impressions, clicks, data collection events, and/or beacon fires that may characterize interactions between users and one or more advertisement campaigns. As discussed herein, such data may also be described as performance data that may form the underlying basis of analyzing a performance of one or more advertisement campaigns. In some embodiments, presentation servers 202 may be front-end servers that may be configured to process a large number of real-Internet users and associated SSL (Secure Socket Layer) handling. The front-end servers may be configured to generate and receive messages to communicate with other servers in system 200. In some embodiments, the front-end servers may be configured to perform logging of events that are periodically collected and sent to additional components of system 200 for further processing.

As similarly discussed above, presentation servers 202 may be communicatively coupled to one or more data sources such as browser 204 and servers 206. In some embodiments, browser 204 may be an Internet browser that may be running on a client machine associated with a user. Thus, a user may use browser 204 to access the Internet and receive advertisement content via browser 204. Accordingly, various clicks and other actions may be performed by the user via browser 204. Moreover, browser 204 may be configured to generate various online advertising data described above. For example, various cookies, advertisement identifiers, beacon fires, and anonymous user identifiers may be identified by browser 204 based on one or more user actions, and may be transmitted to presentation servers 202 for further processing. As discussed above, various additional data sources may also be communicatively coupled with presentation servers 202 and may also be configured to transmit similar identifiers and online advertising data based on the implementation of one or more advertisement campaigns by various advertisement servers, such as advertisement servers 208 discussed in greater detail below. For example, the additional data servers may include servers 206, which may process bid requests and generate one or more data events associated with providing online advertisement content based on the bid requests. Thus, servers 206 may be configured to generate data events characterizing the processing of bid requests and implementation of an advertisement campaign. Such bid requests may be transmitted to presentation servers 202.

In various embodiments, system 200 may further include record synchronizer 207 which may be configured to receive one or more records from various data sources that characterize the user actions and data events described above. In some embodiments, the records may be log files that include one or more data values characterizing the substance of the user action or data event, such as a click or conversion. The data values may also characterize metadata associated with the user action or data event, such as a timestamp identifying when the user action or data event took place. According to various embodiments, record synchronizer 207 may be further configured to transfer the received records, which may be log files, from various end points, such as presentation servers 202, browser 204, and servers 206 described above, to a data storage system, such as data storage system 210 or database system 212 described in greater detail below. Accordingly, record synchronizer 207 may be configured to handle the transfer of log files from various end points located at different locations throughout the world to data storage system 210 as well as other components of system 200, such as data analyzer 216 discussed in greater detail below. In some embodiments, record synchronizer 207 may be configured and implemented as a MapReduce system that is configured to implement a MapReduce job to directly communicate with a communications port of each respective endpoint and periodically download new log files.

As discussed above, system 200 may further include advertisement servers 208 which may be configured to implement one or more advertisement operations. For example, advertisement servers 208 may be configured to store budget data associated with one or more advertisement campaigns, and may be further configured to implement the one or more advertisement campaigns over a designated period of time. In some embodiments, the implementation of the advertisement campaign may include identifying actions or communications channels associated with users targeted by advertisement campaigns, placing bids for impression opportunities, and serving content upon winning a bid. In some embodiments, the content may be advertisement content, such as an Internet advertisement banner, which may be associated with a particular advertisement campaign. The terms “advertisement server” and “advertiser” are used herein generally to describe systems that may include a diverse and complex arrangement of systems and servers that work together to display an advertisement to a user's device. For instance, this system will generally include a plurality of servers and processing nodes for performing different tasks, such as bid management, bid exchange, advertisement and campaign creation, content publication, etc. Accordingly, advertisement servers 208 may be configured to generate one or more bid requests based on various advertisement campaign criteria. As discussed above, such bid requests may be transmitted to servers 206.

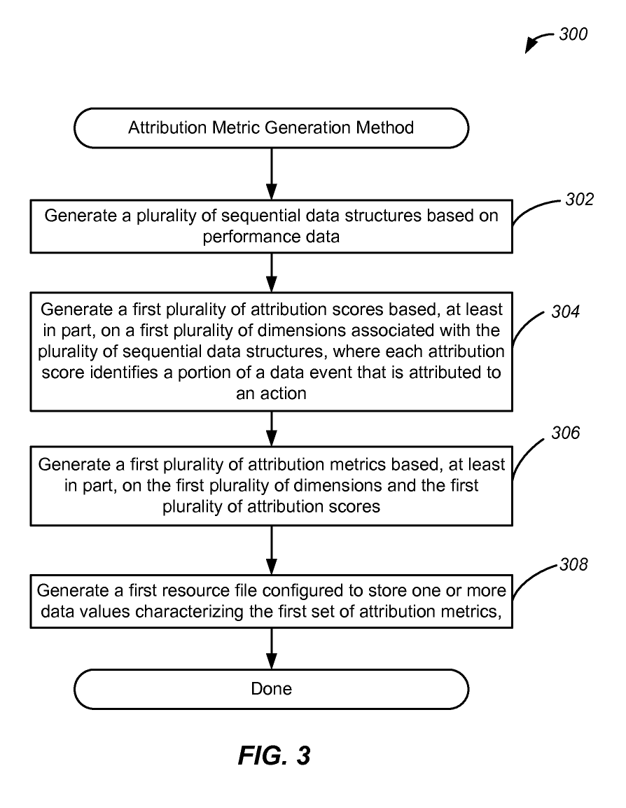

In various embodiments, system 200 may include data analyzer 216 which may be configured to analyze performance data and generate attribution metrics that may be configured or customized for particular online advertisement campaigns and/or sub-campaigns. Accordingly, data analyzer 216 may be configured to generate sequential data structures representing sequences of data events associated with user actions. Moreover, as will be discussed in greater detail below with reference to FIGS. 3-7B, data analyzer 216 may be further configured to implement customized multi-touch attribution operations to attribute the user actions to data events as well as online advertisement campaigns and/or sub-campaigns associated with those data events. Accordingly, data analyzer 216 may generate attribution metrics that characterize the attribution of one or more data events to each action, and may include such attribution metrics in a resource file that may be sent to advertisement servers and used to implement bid requests for a campaign or sub-campaign. Furthermore, as will be discussed in greater detail below, data analyzer 216 may be further configured to analyze multiple different combinations of dimensions associated with the data events to customize the multi-touch attribution operations to a particular online advertisement campaign or sub-campaign. Further still, data analyzer 216 may be communicatively coupled to a data storage system of a data provider, such as data provider 226, and may be configured to receive data records from data provider 226.

Accordingly, data analyzer 216 may include sequential data structure generator 218 which may be configured to generate sequential data structures based on performance data, where the performance data characterizes data events associated with interactions between at least one user and at least one online advertisement campaign or sub-campaign. In various embodiments, the sequential data structures characterize sequential representations of at least some of the data events. Accordingly, sequential data structure generator 218 may analyze the performance data, which may be stored in data storage system 210, and may generate several sequential data structures for sequences of data events that resulted in a user action as well as sequences of data events that did not result in a user action. Moreover, as will be discussed in greater detail below, each data event included in each of the sequential data structures may be identified based on one or more sets of dimensions associated with the plurality of data events. In this way, the sequential data structures as well as the subsequent analysis of the data structures may be customized to a particular campaign or sub-campaign as determined by the dimensions included in the dimension set.

Data analyzer 216 may further include attribution metric generator 220 which may be configured to generate attribution scores and attribution metrics based on the sequential data structures. In various embodiments, each attribution score may identify a portion or fraction of a data event that is attributed to an action. In various embodiments, the data event that is attributed to an action may be included in a sequence of events that resulted in the action. In this way, one or more data events included in a sequential data structure may be fractionally or entirely attributed to an action. In various embodiments, attribution metric generator 220 may be configured to generate attribution metrics based, among other things, on the attribution scores. In some embodiments, each of the attribution metrics may identify a number of actions attributed to an online advertisement entity, such as a campaign or sub-campaign. Moreover, the attribution metrics may identify a probability associated with the online advertisement entity. For example, a particular attribution metric may identify a probability that the implementation of a sub-campaign may result in a user action. As discussed in greater detail below, the attribution of the action to the data events may be implemented based on the various dimensions that may have been specified by an initial set of dimensions, which may have been selected or identified by an advertiser or system administrator.

Data analyzer 216 may also include resource file generator 222 which may be configured to generate resource files that may be configured to store one or more data values characterizing the attribution metrics. Accordingly, each resource file may include various data, such as aggregate performance data, as well as attribution metrics associated with various campaigns and/or sub-campaigns. As will be discussed in greater detail below, according to some embodiments, each resource file generated may be specific to a particular set of dimensions, and thus may be specific to a particular campaign or sub-campaign, or a particular view of a campaign or sub-campaign. Moreover, a resource file may be capable of being provided to advertisement servers, such as advertisement servers 208, which may be used to implement an online advertisement campaign. Accordingly, advertisement servers 208 may utilize the attribution metrics included in a received resource file to determine an amount of a bid that should be included in a bid request. As will be discussed in greater detail below, such a determination of a bid request may be made by analyzing the attribution metric in conjunction with another designated advertisement parameter, which may have a designated value, such as an estimated or desired cost per action.

In various embodiments, data analyzer 216 or any of its respective components may include one or more processing devices configured to process performance data received from various data sources, such as a data storage system operated and maintained by an online advertisement service provider, such as Turn® Inc., Redwood City, Calif. In some embodiments, data analyzer 216 may include one or more communications interfaces configured to communicatively couple data analyzer 216 to other components and entities, such as a data storage system and a record synchronizer. Furthermore, as similarly stated above, data analyzer 216 may include one or more processing devices specifically configured to process data associated with data events, online users, and websites. In one example, data analyzer 216 may include several processing nodes, specifically configured to handle processing operations on large data sets. For example, data analyzer 216 may include a first processing node configured as sequential data structure generator 218, a second processing node configured as attribution metric generator 220, and a third processing node configured as resource file generator 222. In another example, sequential data structure generator 218 may include data processing nodes for processing large amounts of performance data in a distributed manner. In one specific embodiment, data analyzer 216 may include one or more application specific processors implemented in application specific integrated circuits (ASICs) that may be specifically configured to process large amounts of data in complex data sets, as may be found in the context referred to as “big data.”

In some embodiments, the one or more processors may be implemented in one or more reprogrammable logic devices, such as a field-programmable gate array (FPGAs), which may also be similarly configured. According to various embodiments, data analyzer 216 may be implemented as a controller, which may be a hardware controller. Moreover, data analyzer 216 may be configured to include one or more dedicated processing units that include one or more hardware accelerators configured to perform pipelined data processing operations. For example, as discussed in greater detail below, operations associated with the generation of sequential data structures and attribution metrics may be handled, at least in part, by one or more hardware accelerators included in sequential data structure generator 218 and attribution metric generator 220, respectively.

In various embodiments, such large data processing contexts may involve performance data stored across multiple servers implementing one or more redundancy mechanisms configured to provide fault tolerance for the performance data. In some embodiments, a MapReduce-based framework or model may be implemented to analyze and process the large data sets disclosed herein. Furthermore, various embodiments disclosed herein may also utilize other frameworks, such as .NET or grid computing.

In various embodiments, system 200 may include data storage system 210. In some embodiments, data storage system 210 may be implemented as a distributed file system. As similarly discussed above, in the context of processing online advertising data from the above described data sources, there may be many terabytes of log files generated every day. Accordingly, data storage system 210 may be implemented as a distributed file system configured to process such large amounts of data. In one example, data storage system 210 may be implemented as a Hadoop® Distributed File System (HDFS) that includes several Hadoop® clusters specifically configured for processing and computation of the received log files. For example, data storage system 210 may include two Hadoop® clusters where a first cluster is a primary cluster including one primary namenode, one standby namenode, one secondary namenode, one Jobtracker, and one standby Jobtracker. The second node may be utilized for recovery, backup, and time-costing query. Furthermore, data storage system 210 may be implemented in one or more data centers utilizing any suitable multiple redundancy and failover techniques.

In various embodiments, system 200 may also include database system 212 which may be configured to store data generated by data analyzer 216. In some embodiments, database system 212 may be implemented as one or more clusters having one or more nodes. For example, database system 212 may be implemented as a four-node RAC (Real Application Cluster). Two nodes may be configured to process system metadata, and two nodes may be configured to process various online advertisement data, which may be performance data, that may be utilized by data analyzer 216. In various embodiments, database system 212 may be implemented as a scalable database system which may be scaled up to accommodate the large quantities of online advertising data handled by system 200. Additional instances may be generated and added to database system 212 by making configuration changes, but no additional code changes.

In various embodiments, database system 212 may be communicatively coupled to console servers 214 which may be configured to execute one or more front-end applications. For example, console servers 214 may be configured to provide application program interface (API) based configuration of advertisements and various other advertisement campaign data objects. Accordingly, an advertiser may interact with and modify one or more advertisement campaign data objects via the console servers. In this way, specific configurations of advertisement campaigns may be received via console servers 214, stored in database system 212, and accessed by advertisement servers 208 which may also be communicatively coupled to database system 212. Moreover, console servers 214 may be configured to receive requests for analyses of performance data, and may be further configured to generate one or more messages that transmit such requests to other components of system 200.

FIG. 3 illustrates a flow chart of an example of an attribution metric generation method, implemented in accordance with some embodiments. In various embodiments, an attribution metric generation method, such as method 300, may be implemented to attribute actions, which may be user actions associated with online advertisement campaigns, to data events which may characterize or represent interactions between the user and an online advertisement campaign. As will be discussed in greater detail below, such attribution of actions to campaigns and sub-campaigns may be based on multiple different combinations of multiple dimensions of the data events, thus enabling the customized implementation of an attribution technique that may be customized to a specific campaign or sub-campaign, and utilized to generate a customized resource file for that campaign or sub-campaign.

Accordingly, method 300 may commence with operation 302 during which a plurality of sequential data structures may be generated based on performance data. In some embodiments, the performance data may characterize data events associated with interactions between at least one user and at least one online advertisement entity. In various embodiments, an online advertisement entity may be an online advertisement campaign or sub-campaign. Moreover, each of the plurality of sequential data structures may characterize a sequential representation of at least some of the data events during a first time period. Accordingly, the generated sequential data structures may each represent sequences of data events that may or may not have led to an action, which may be a user action such as a click-through or purchase of a product. Furthermore, each data event included in each of the plurality of sequential data structures may be identified based on a first set of dimensions associated with the data events. As disclosed herein, a dimension may refer to a feature or characteristic of a data event or a user associated with a data event, such as biographical information, geographical information, network information, an identify of a top-level-domain that was used to generate the data event, etc. Accordingly, as will be discussed in greater detail below, several different dimensions may be analyzed in combination to identify data events and attribute actions to data events and their associated campaigns and/or sub-campaigns in a way that is customized for a particular advertisement campaign or sub-campaign.

Method 300 may proceed to operation 304 during which a first plurality of attribution scores may be generated based, at least in part, on the first plurality of dimensions associated with the plurality of sequential data structures. In some embodiments, each attribution score identifies a portion of a data event that is attributed to an action. As will be discussed in greater detail below, an attribution technique, such as a multi-dimensional multi-touch attribution technique, may be implemented to attribute actions to data events that occurred in a sequence of events leading to that particular action, as may be represented in a sequential data structure. In this way, user actions of interest, such as clicks and purchases of products, may be attributed to multiple data events in a sequence of data events and based on multiple dimensions of the data events. As will be discussed in greater detail below, this may be performed for several different dimensions sets, thus enabling the analysis of several different combinations of dimensions sets.

Method 300 may proceed to operation 306 during which a first plurality of attribution metrics may be generated based, at least in part, on the first plurality of dimensions and the first plurality of attribution scores. In various embodiments, each of the first plurality of attribution metrics identifies a number of actions attributed to an online advertisement entity. Accordingly, the attribution metrics may represent an overall indication of how many actions were attributed to a campaign or sub-campaign and/or a probability that the implementation of the campaign or sub-campaign, or one of its components such as an advertisement, may result in a desired user action. As will be discussed in greater detail below, each of the first plurality of attribution metrics may be generated based on multiple attribution scores and multiple dimensions included in each sequential data structure that resulted in an action associated with the at least one online advertisement entity.

Method 300 may proceed to operation 308 during which a first resource file may be generated. In some embodiments, the first resource file may be configured to store one or more data values characterizing the first set of attribution metrics. Accordingly, the resource file may include various other information, such as aggregate performance data associated with various campaigns and sub-campaigns. As discussed above, such attribution metrics may have been determined based on a multi-dimensional multi-touch attribution technique. As will be discussed in greater detail below, the first resource file may be capable of being provided to an advertisement server as well as be capable of being used to generate at least one message including a bid request. Thus, the advertisement server may be configured to utilize the attribution metrics to generate and submit bids for impression opportunities. Moreover, the resource file may be configured to present such attribution metrics in a manner that is configured to a set of dimensions utilized by the advertisement server to implement the bid requests.

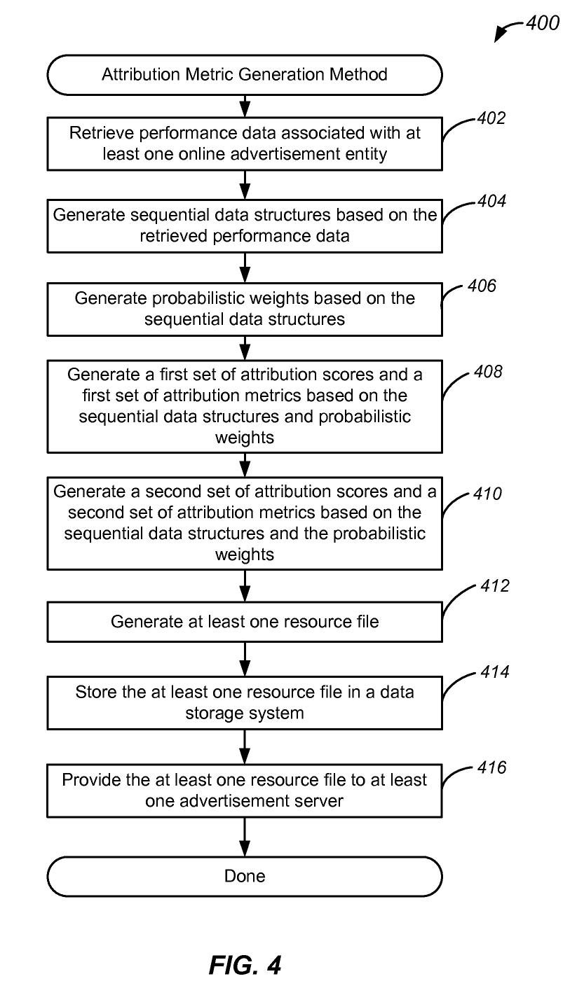

FIG. 4 illustrates a flow chart of another example of an attribution metric generation method, implemented in accordance with some embodiments. As previously discussed, different sets of dimensions may be specified by an entity, such as an advertiser, to configure the implementation of data event attribution associated with an advertisement campaign, as well as configure bid requests associated with that advertisement campaign. Accordingly, a method, such as method 400, may be implemented to analyze different dimension sets such that attribution scores and metrics may be generated that are configured based on each dimension set, and provide a highly accurate attribution of actions to data events in view of a particular dimension set. Moreover, the determination of such attribution scores and metrics as well as the subsequent generation of resource files for different dimension sets may be performed as part of a single query process, thus reducing the amount of processing overhead associated with the generation of the attribution scores.

Method 400 may commence with operation 402 during which performance data associated with at least one online advertisement entity may be retrieved. As discussed above, an online advertisement entity may be an advertisement campaign or sub-campaign. In various embodiments, the performance data may include various data events, such as impressions, clicks, and actions. In some embodiments, the performance data may also include some user profile data which may characterize various features and data categories of users associated with the data events. The performance data may further include various identifiers for each data event that characterize or identify features or entities associated with the data event, such as an advertiser identifier that identifies an advertiser that provided an advertisement underlying the data event, as well as a campaign identifier that identifies an online advertisement campaign that includes the advertisement. Such identifiers may also identify other aspects of each data event, such as a top level domain (TLD) that served an impression, an advertisement category associated with the advertisement, a publisher that was used to publish the advertisement, geographical data, technological data, such as an operating system used, etc. As disclosed herein, such dimensions or features may be any suitable feature associated with a user, publisher, and advertiser domain such as a gender, advertisement code or identifier, and creative layout code or identifier. Such performance data may have been generated based on previous online advertisement campaign activity associated with online advertisement campaigns implemented by advertisers that may subscribe to services provided by an online advertisement service provider. The performance data may be stored in a data storage system operated and maintained by the online advertisement service provider. Accordingly, the online advertisement service provider may log, store, and maintain performance data for online advertisement campaigns in a storage system that is queryable to support the subsequent analysis of such data.

In various embodiments, during operation 402, such a data storage system may be queried and performance data may be retrieved. The performance data may be identified based on identifiers as well as metadata. For example, if method 400 is being implemented for a particular advertiser and for a particular advertisement campaign or sub-campaign, then relevant performance data may be identified by querying the performance data and identifying performance data that includes matching advertiser identifiers and campaign identifiers. Furthermore, timestamp metadata may be used to constrain the query to a designated time window or time period. For example, performance data generated within the past 30 days may be analyzed. Such constraints may be determined by the advertiser or by the online advertisement service provider.

Furthermore, performance data may be identified based on a combination of several different characteristics or dimensions associated with the performance data. As previously discussed, a data event may be stored as a data structure that includes various data characterizing the event, such as a type of event and a time of creation. The data structure may also include various other associated data characterizing additional characteristics or dimensions of the data event and entities associated with the data event, such as an identity of an advertiser, an online advertisement campaign, a user, a type of user, an advertisement category, a TLD, geographical information, etc. Accordingly, a combination of dimensions may be used to identify and retrieve the relevant performance data during operation 402. As will be discussed in greater detail below, the combinations of dimensions used to retrieve performance data may be predetermined based on designated combinations of dimensions which may be determined by an online advertisement service provider, or may be determined based on data retrieved from previous iterations of method 400. In some embodiments, the combinations of dimensions may be determined based on one or more data values retrieved from a bid request, or advertisement associated with a bid request, which may identify a user, publisher, and/or advertiser as well as other features such as whether a user us a returning user, other user behavioral and page content information. In this way, such retrieval of performance data based on one or more combinations of dimensions may be performed responsive to a bid request or its associated advertisement, or may be performed prior to such bid request or associated advertisement.

Method 400 may proceed to operation 404 during which sequential data structures may be generated based on the retrieved performance data. Thus, according to some embodiments, the performance data may be arranged into one or more sequential data structures which may also be referred to herein as sequences. The sequences may include one or more data values which identify a series of data points or data events that occurred for a particular user prior to the occurrence or non-occurrence of a user action. Thus, data events included in a sequence of events may be arranged and stored as a sequential representation of those data events. In some embodiments, the data values included in each sequence are filtered based on a user identifier, and are specific to a particular user's experience within an advertisement context. For example, a user may have purchased a product and, thus, completed a user action. Prior to the user action and within the predetermined period of time discussed above, the user may have viewed four advertisements from three different sub-campaigns, where each view would be identified and stored as a data event associated with the user based on a user identifier which may be retrieved from any suitable source, such as login information, mobile device information, or pattern recognition techniques. Accordingly, the sequence associated with the user action may include several data values that identify the user, the user action, and each of the four data events associated with the three sub-campaigns.

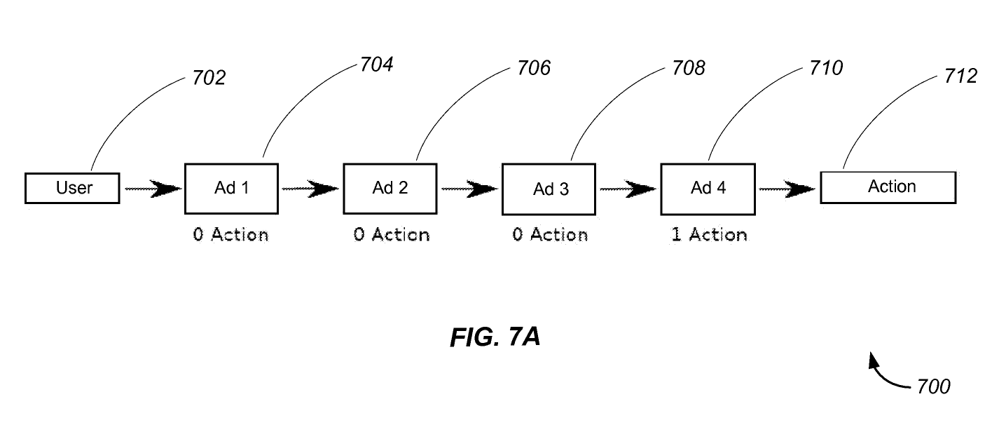

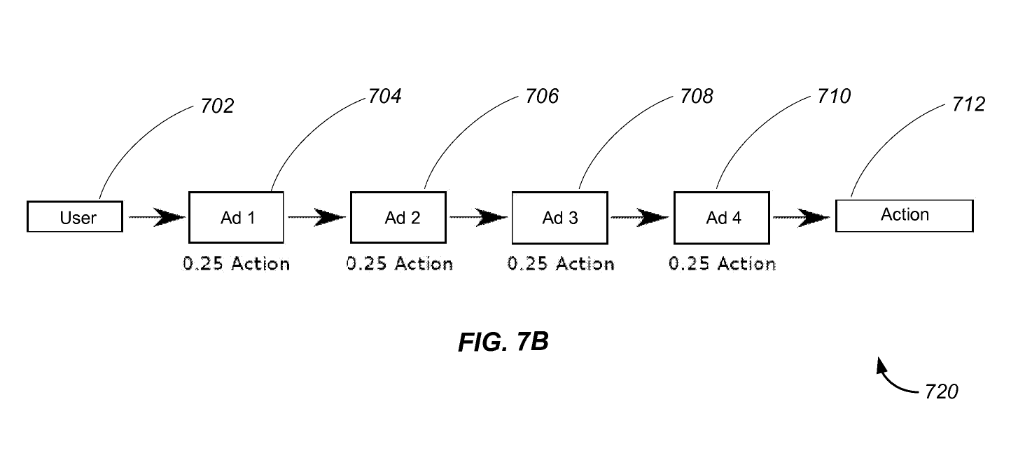

The order of the data events within the sequential representation may be determined based on one or more characteristics or features associated with the data events, such as timestamp metadata. In various embodiments, sequences are generated and constructed as data structures for sequences of events that ended in no user action, as well as sequences of events that resulted in a user action. Additional details of sequential data structures are discussed with reference to FIG. 7A and FIG. 7B.

As will be discussed in greater detail below, the sequential data structures may be configured to support one or more dimension sets that may be determined by an advertiser or an online advertisement service provider. As previously discussed, the dimensions sets may identify a combination of characteristics, features, or dimensions of data events. For example, a first dimension set may include a campaign identifier, an advertisement category, and a TLD that was used to serve an advertisement underlying a data event. As previously discussed, the data events included in a sequential data structure may be identified based, at least in part, on various data included in each data event, such as temporal metadata as well as data values identifying a user that may have interacted with an advertisement campaign and generated the data event. Accordingly, each data event may be configured to store data values characterizing multiple dimensions, such as those discussed above with reference to the first dimension set that includes a campaign identifier, an advertisement category, and a TLD.

Moreover, the sequential data structures that include the extracted sequences may be further processed to facilitate subsequent analysis. For example, sequences that ended in a user action, such as a purchase of a product or the filling out of a form, may be marked, flagged, or identified by a system component, such as a sequential data structure analyzer, as a sequence that resulted in a user action. This identification may be accomplished by the inclusion of a flag or identifier in the data structure or generation of a mapping matrix stored elsewhere in the database system. Similarly, sequences that ended in no user action, such as no purchase being made, may be marked, flagged, or identified by a system component, such as a control server, as a sequence that did not result in a user action. Furthermore, for each sequence that leads to a user action, the control server may identify and record the identity of each campaign or sub-campaign associated with a data event included in the sequence. Moreover, for each sequence that did not lead to a user action, the sequential data structure analyzer may identify and record the identity of each campaign or sub-campaign associated with a data event included in the sequence. In this way, the sequential data structure analyzer may determine how many data events lead to a user action and did not lead to a user action for each campaign or sub-campaign.

Method 400 may proceed to operation 406 during which probabilistic weights may be generated based on the sequential data structures. In various embodiments, the probabilistic weights may characterize or identify the probability of an advertisement entity, such as an advertisement campaign or sub-campaign, being in a sequence that ends in a user action. In various embodiments, the probabilistic weight associated with a campaign or sub-campaign may be determined by calculating the number of sequences that the campaign or sub-campaign was included in that resulted in a user action to generate a first number, calculating the total number of sequences that the campaign or sub-campaign was in (regardless of whether such line item or sub-campaign resulted in a user action) to generate a second number, and then dividing the first number by the second number. As similarly discussed above with reference to operation 404, such numbers may be generated by processing identifiers included in data events for each of the extracted sequences. In another example, after construction of the action and non-action sequences, the sequences may be stored in a database system as a data table and may be filtered or viewed based on an associated sub-campaign or campaign identifier. Thus, for a particular sub-campaign or campaign, all relevant sequences that resulted in a user action may be available and readily identifiable, as well as all sequences that did not result in a user action. By viewing the number of entries in the data table, a system component, such as a sequential data structure analyzer, may readily determine how many sequences are included in each category for each campaign or sub-campaign. Thus, the probabilistic weight for a particular line item may be determined by dividing the number of sequences resulting in a user action by the sum of the number of sequences resulting in a user action and the number of sequences not resulting in a user action. Each probabilistic weight may be stored in the database system for subsequent use, as will be discussed in greater detail below.

In various embodiments, operations 402, 404, and 406 may be implemented as a first MapReduce job. For example, operations 402, 404, and 406 may be implemented as an Oozie job implemented in Java in a Hadoop framework. As discussed above with reference to FIG. 2, such a framework may be operated and maintained by an online advertisement service provider. As will be discussed in greater detail below, additional MapReduce jobs may be utilized to implement additional operations within method 400.

Method 400 may proceed to operation 408 during which a first set of attribution scores and a first set of attribution metrics may be generated based on the probabilistic weights and sequential data structures. As disclosed herein, attribution scores may include one or more data values configured to characterize or identify a portion of an action attributed to an advertisement campaign, sub-campaign, or components of a campaign or sub-campaign, such as an advertisement. Accordingly, the previously generated sequential data structures that include sequences of data events that resulted in actions may be analyzed, and attribution scores may be generated for at least some of the data events included in the sequential data structures. In some embodiments, the sequential data structures may be processed to reduce duplicative data events prior to the generation of attribution scores. For example, if a sequence includes multiple instances of the same advertisement, the multiple instances may be identified, and all but one instance may be discarded.

In various embodiments, the attribution scores may be determined based on the previously generated probabilistic weights as well as the previously described sets of dimensions. More specifically, for a particular sequential data structure being analyzed, a system component, such as an attribution metric generator, may analyze all data events included in the sequence, and identify a campaign or sub-campaign associated with each data event, retrieve the probabilistic weight for that campaign or sub-campaign, and assign a probabilistic weight to each data event. For example, a sequence being analyzed may include a first data event that represents the presentation of a first advertisement of a first sub-campaign, a second data event that represents the presentation of a second advertisement of a second sub-campaign, a third data event that represents the presentation of a third advertisement that may also be of the first sub-campaign, and a fourth data event that represents the presentation of a fourth advertisement of a third sub-campaign. The attribution metric generator may identify the first, second, and third sub-campaigns based on identifiers included in the data events, and may retrieve probabilistic weights for the first, second, and third sub-campaigns. The attribution metric generator may then assign first, second, and third probabilistic weights to the first, second, and third sub-campaigns respectively.

In various embodiments, the generation of the attribution scores may be configured based on one or more dimensions, as may be determined by one or more dimensions sets. For example, data events in sequences may include multiple dimensions such as sub-campaign identifiers and publisher identifiers. In various embodiments, attribution scores may be generated based on the sub-campaign identifiers, and additional attribution scores may be generated based on the publisher identifiers. More specifically, the attribution metric generator may analyze the data events included in a sequence based on the sub-campaign identifier dimension, and optionally filter the data events included in the sequence based on the sub-campaign identifier dimension. The attribution metric generator may then apportion the probabilistic weights and generate attribution scores as discussed above and in greater detail below. The attribution metric generator may also analyze and optionally filter the data events based on the publisher identifier dimension and again generate additional probabilistic weights and attribution scores. In this way, the attribution metric generator may be configured to analyze the sequences based on different sets of dimensions, and apportion probabilistic weights and generate a set of attribution scores for each set of dimensions that has been analyzed. While this example, describes analyzing a dimension, such as a sub-campaign identifier, multiple dimensions may be analyzed at the same time. For example, the attribution metric generator may analyze the data events based on a set of dimensions that includes a publisher identifier, a TLD, and a gender. As will be discussed in greater detail below, resource files may be generated based on each set of dimensions.

In this way, the sequences of data events may be analyzed multiple times for multiple different sets of dimensions to generate multiple log files including attribution metrics, where each of the log files is configured for a particular set of dimensions. Thus, such log files may be easily provided to advertisement servers when implementing bidding requests. As discussed in greater detail below, the bidding requests implemented by such advertisement servers may be implemented based on particular sets of dimensions, and specific sets of dimensions may underlie the calculations of the bids themselves. Accordingly, because custom log files have been generated that are configured to those specific sets of dimensions, the log files may be provided to the advertisement servers to enable bidding, thus reducing processing overhead that may otherwise be incurred by additional scans of the performance data and additional calculations for each set of dimensions.

Furthermore, the attribution metric generator may normalize the probabilistic weights by summing the values of all of the probabilistic weights assigned for a particular sequence, and dividing each probabilistic weight that was assigned for that sequence by the total that was determined by the summing. In various embodiments, the normalized probabilistic weight may be assigned to each respective data event as an attribution score. Accordingly, during operation 408, the generation of attribution scores may be performed for each sequential data structure that resulted in an action. Moreover, attribution metrics may be determined based on the attribution scores. For example, attribution scores may be summed for a particular campaign or sub-campaign to generate an attribution metric for that campaign or sub-campaign. In some embodiments, the sum of the attribution scores may be divided by a total number of sequences (action and non-action) that the campaign or sub-campaign appeared in to generate an attribution metric that represents or characterizes a probability associated with the campaign or sub-campaign.

In some embodiments, operation 408 may be implemented as a second MapReduce job that may also be implemented as an Oozie job implemented in Java in a Hadoop framework. In various embodiments, the second MapReduce job may be implemented following the first MapReduce job.

Method 400 may proceed to operation 410 during which a second set of attribution scores and a second set of attribution metrics may be generated based on the sequential data structures. In various embodiments, a parallel pipeline may be implemented within the attribution metric generator to generate a second set of attribution scores based on a last-touch attribution method. In some embodiments, the second set of attribution scores may be based on a single dimension. For example, as similarly discussed above, sequential data structures may be generated based on performance data. However, instead of analyzing each data event included in each sequential data structure, the attribution metric generator may identify the last data event in each sequence that resulted in an action, and may assign the last data event an attribution score representing 100% attribution. For example, the attribution score may be a numerical value such as “1”, or may be a flag or other Boolean indicator. In this way, for sequences that resulted in an action a second set of attribution scores may be generated that utilize a last-touch attribution technique. Furthermore, as stated above, the generation of the second set of attribution scores may occur in parallel with the generation of the first set of attribution scores discussed above with reference to operations 404, 406, and 408. Accordingly, while FIG. 4 illustrates operation 410 as occurring after operations 404, 406, and 408, operation 410 may be implemented parallel to operations 404, 406, and 408. Further still, as discussed above, second attribution metrics may be generated based on the second attribution scores. For example, the second attribution scores may be summed for a particular campaign or sub-campaign to generate an attribution metric for that campaign or sub-campaign. In some embodiments, the sum of the attribution scores may be divided by a total number of sequences (action and non-action) that the campaign or sub-campaign appeared in to generate second attribution metrics that represent or characterize a probability associated with the campaign or sub-campaign.

Method 400 may proceed to operation 412 during which at least one resource file may be generated. As discussed above, a resource file may be a data object that includes data values characterizing an aggregate of past performance data associated with online advertisement campaigns or sub-campaigns. For example, a resource file may include a data table that identifies data events as well as various dimensions of the data event, such as a TLD, publisher, advertisement identifier, advertiser identifier, geographical information, etc. During operation 412, resource files may be generated based on the sets of dimensions underlying method 400 as well as the first and second sets of attribution metrics. Accordingly, a system component, such as a resource file generator, may generate a resource file for each set of dimensions utilized during operations 404, 406, and 408. Each resource file may also be configured to include a column of data values that includes attribution metrics associated with each campaign or sub-campaign. For example, a resource file for a first set of dimensions may include first attribution metrics for each campaign or sub-campaign associated with data events that were identified based on the first set of dimensions. As previously discussed, such first attribution metrics may have been determined utilizing a multi-touch attribution method. Furthermore, as stated above, there may be numerous different sets of dimensions that were analyzed during operations 404, 406, and 408. Accordingly, during operation 412, numerous resource files may be generated. For example, if there are 20 different sets of dimensions, 20 different resource files may be generated. In this way, numerous different sets of dimensions may be analyzed efficiently, and numerous resource files may be generated. The resource file generator may also generate a resource file for the last-touch attribution technique used during operation 410.

Method 400 may proceed to operation 414 during which the at least one resource file may be stored in a data storage system. Accordingly, the resource files generated during operation 412 may be provided to the data storage system operated and maintained by the online advertisement service provider. In this way, the performance data stored in the data storage system may be updated to include the first and second attribution metrics. Moreover, the performance data may be stored in aggregate data files that provide ordered representations of data events over a designated period of time.

Method 400 may proceed to operation 416 during which the at least one resource file may be provided to advertisement servers. As previously discussed, the advertisement servers may be configured to submit one or more bid requests based on various parameters such as a probability associated with a campaign or sub-campaign, as well as a designated parameter which may be determined by an advertiser. In some embodiments, the designated parameter may be a goal or target specified by the advertiser, such as a desired cost per action. For example, an advertisement server may determine a value for a bid request by multiplying the probability with the designated parameter. In various embodiments, the probability may be determined based on the resource files. For example, an advertisement server may receive a resource file. When serving an advertisement having an associated entry in the resource file, which may be a data event corresponding the serving of that specific advertisement, the advertisement server may query the resource file, identify a first attribution metric and utilize that first attribution metric as a probability to determine the value of the bid request. In this way, the advertisement servers may utilize the multi-dimensional multi-touch-based attribution metrics determined by method 400.

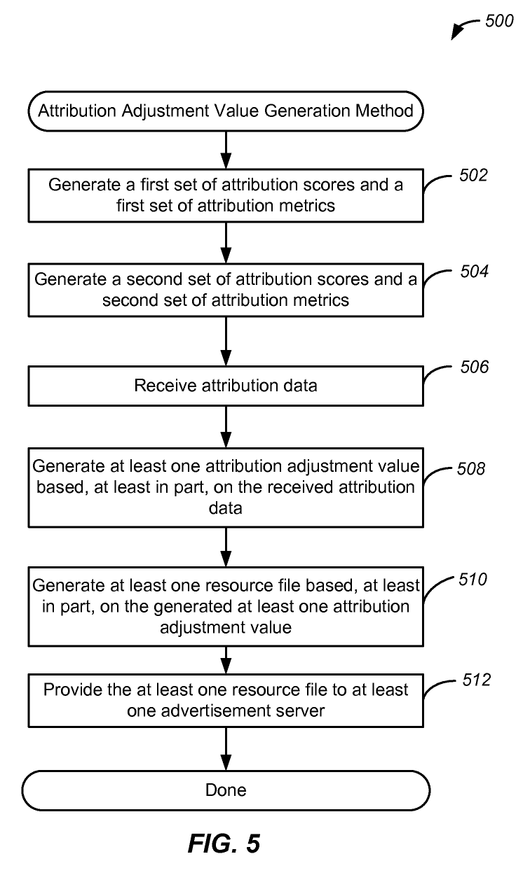

FIG. 5 illustrates a flow chart of an example of an attribution adjustment value determination method, implemented in accordance with some embodiments. In various embodiments, adjustment values may be generated and implemented to approximate a multi-dimensional multi-touch attribution based on available last-touch attribution data as well as available single-dimension multi-touch attribution data. As discussed in greater detail below, the available last-touch attribution data may itself be multi-dimensional, and may be determined based on one or more combinations of various dimensions. Accordingly, attribution adjustment values may be calculated that may be configured to enable advertisement servers to modify bid requests generated based on the last-touch attribution data, such that the modified bid requests approximate bid requests that would have been generated based on multi-dimensional multi-touch attribution data if it were available.

Accordingly, method 500 may commence with operation 502 during which multi-touch attribution scores may be generated. As similarly discussed above, a system component, such as the sequential data structure analyzer, may analyze the data events included in the sequential data structures. Furthermore, the sequential data structure analyzer may determine several probabilistic weights. In contrast to the attribution scores generated during method 400, the attribution scores generated during operation 502 may be generated utilizing a single dimension, such as a campaign or sub-campaign associated with each data event. Accordingly, as similarly discussed above, the sequential data structure analyzer may generate a weight for each sub-campaign or campaign that was associated with a data event that resulted in an action. The weights may be normalized and assigned to data events that are included in sequences that resulted in actions. In this way, the sequential data structure analyzer may generate multi-touch attribution scores for the data events included in the analyzed data structures.

Method 500 may proceed to operation 504 during which last-touch attribution scores may be generated. As similarly discussed above, the last-touch attribution scores may be generated by retrieving past performance data which by querying a data storage system. The query may be constrained by a first time period or window. A system component, such as a sequential data structure analyzer, may be configured to analyze the retrieved data and construct various sequential data structures characterizing users' interactions with one or more online advertisement campaigns. As discussed above, each sequential data structure may include a sequence of data events that may or may not result in an action. During operation 504, the sequential data structure analyzer may analyze each sequence that resulted in an action, and may identify the last data event in each analyzed sequence. Furthermore, the sequential data structure analyzer may assign each identified last data event a last-touch attribution score that associates the last data event with the action, and attributes that action to the data event. In some embodiments, the last-touch attribution scores may be multi-dimensional, and may be calculated or determined based on a combination of dimensions.

In some embodiments, either or both of operations 502 and 504 may include receiving data from a third party. Accordingly, a third party may have generated the last-touch attribution scores and multi-touch attribution scores, and included such data in one or more data records that are provided to the online advertisement service provider. Accordingly, in some embodiments, during operations 502 and 504, the online advertisement service provider may receive the last-touch attribution scores and multi-touch attribution scores, and may store them in a data storage system.

Method 500 may proceed to operation 506 during which attribution data may be retrieved. In various embodiments, the attribution data may be a specific set of data that is retrieved to form the underlying basis of the determination of an attribution adjustment value, discussed in greater detail below. For example, the attribution data may include last-touch attribution scores and multi-touch attribution scores that were previously generated and associated with data events occurring within one or more time periods, such as a second time period, which may be different than the first time period discussed above. Accordingly, operations 502 and 504 may be performed as part of an ongoing background process performed by an online advertisement service provider when implementing various advertisement campaigns for advertisers over a large time period. The attribution data retrieved during operation 506 may be for a different time period, which may be smaller than the first, and may be more specific to a particular advertisement campaign.

Thus, according to some embodiments, attribution data may be retrieved for a second time period. The second time period may be determined based on a designated time parameter associated with the calculation of the last-touch attribution scores and/or the multi-touch attribution scores. For example, the attribution metric generator may be configured to calculate multi-touch attribution scores based on 30 days of previous data. Accordingly, the second time period may be determined to include data generated from 30 days in the past, relative to the date the method 500 is implemented, to as far back as data is available. In some embodiments, an additional constraint may be implemented such that the second time period extends from 30 days in the past to, for example, 6 months in the past or 1 year in the past. Accordingly, once the second time period has been determined, the data storage system may be queried and last-touch attribution scores and multi-touch attribution scores generated for data events included in that time period may be retrieved. In various embodiments, the attribution data may include aggregate representations of the attribution scores. For example, the attribution data may include a total number of last-touch actions and a total number of multi-touch actions, where the total numbers of actions are identified based on aggregations or sums of attribution scores.

Method 500 may proceed to operation 508 during which at least one attribution adjustment value may be generated. In various embodiments, an attribution adjustment value may be configured to utilize a relationship between the last-touch attribution scores and multi-touch attribution scores to generate a metric which may be applied to subsequent bidding operations, discussed in greater detail below, to approximate multi-touch attribution during the implementation of bidding operations. In some embodiments, the attribution adjustment value may be determined by analyzing a ratio between last-touch actions and multi-touch actions. For example, the attribution adjustment value may be determined by dividing the total number of multi-touch attribution actions by the total number of last-touch attribution actions for a particular line item or sub-campaign. As previously discussed, such total numbers may be determined based on aggregates of the attribution scores associated with the line items and sub-campaigns included in sequences that resulted in actions.

Method 500 may proceed to operation 510 during which at least one resource file may be generated. As similarly discussed above, resource files may be generated that include aggregate performance data as well as dimensional data associated with the aggregate performance data. Moreover, a resource file may include at least one attribution adjustment value generated during operation 508. Accordingly, the resource file may be configured to include additional data structures, such as columns in a data table, that store the generated attribution adjustment values for various advertisement entities, such as a line items or sub-campaigns. Thus, for each sub-campaign identified during operation 508, the resource file may store an associated last-touch attribution score which may characterize an aggregate number of last-touch actions which may have been determined based on a combination of multiple dimensions. Moreover, the resource file may also store an attribution adjustment value that was calculated for that particular sub-campaign based on the retrieved attribution data.

Method 500 may proceed to operation 512 during which the at least one resource file may be provided to at least one advertisement server. As similarly discussed above, advertisement servers may receive the resource file and may implement bid requests based on the last-touch attribution scores and attribution adjustment values included in the resource file. As previously discussed, bids may be determined based on a product or result of multiplying a probability, which may be determined based on a number of actions divided by a total number of instances such as impressions, with a target result, which may be determined based on a parameter specified by an advertiser such as a target cost per action. In various embodiments, the result of this calculation may be further multiplied by the attribution adjustment value to adjust the bid request based on the previously analyzed multi-touch attribution data. In this way, the advertisement servers may implement an approximation of a multi-dimensional multi-touch attribution technique while utilizing multi-touch attribution data having only a single dimension.

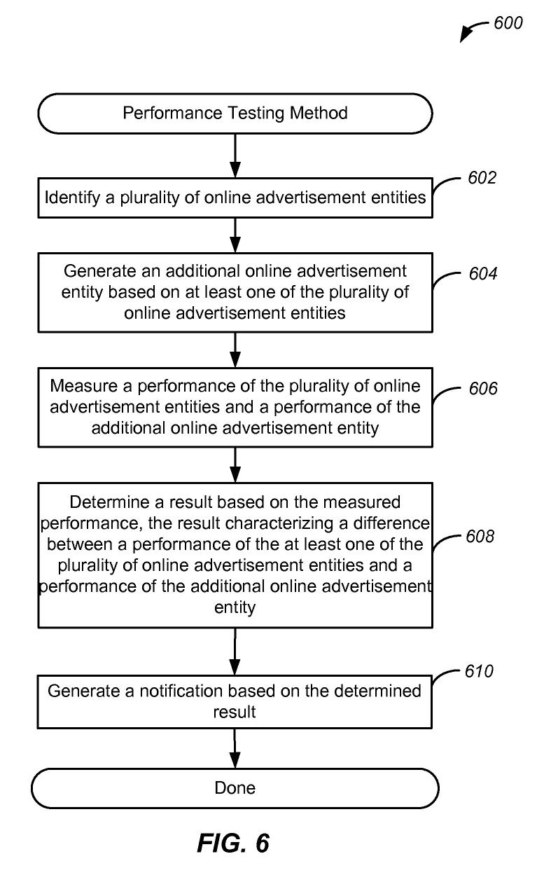

FIG. 6 illustrates a flow chart of an example of a performance testing method, implemented in accordance with some embodiments. In various embodiments, an advertiser may have implemented various online advertisement campaigns or sub-campaigns utilizing a first attribution technique, such as a last-touch attribution technique. The advertiser may contemplate transitioning to a different attribution technique to potentially achieve a more accurate representation of the performance of the advertiser's campaigns or sub-campaigns. Accordingly, a performance testing method, such as method 600, may be implemented to generate a representation of a difference in performances of various campaigns or sub-campaigns if a second attribution technique, such as a multi-dimensional multi-touch attribution technique, is used.

Accordingly, method 600 may commence with operation 602 during which a plurality of online advertisement entities may be identified. In various embodiments, the plurality of online advertisement entities may be campaigns and/or sub-campaigns that may be identified based on an advertisement identifier. For example, an advertiser may choose, via a user interface provided by a console server, to analyze a difference between last-touch attribution to multi-touch attribution, as well as any increase in performance resulting from the implementation of the multi-touch attribution techniques discussed above. Accordingly, one or more advertisement campaigns may be identified based on a selection made by the advertiser.

Method 600 may proceed to operation 604 during which during which an additional online advertisement entity may be generated. Accordingly, an additional campaign or sub-campaign may be generated based, at least in part, on one of the plurality of online advertisement campaigns and/or sub-campaigns that were identified during operation 602. For example, the additional campaign or sub-campaign may be a clone or duplication of one of the campaigns or sub-campaigns identified during operation 602, which may be referred to as a model campaign or sub-campaign. Accordingly, the additional campaign or sub-campaign may have the same targeting criteria and may be configured the same as the model, but may utilize the multi-dimensional multi-touch attribution method discussed above with reference to FIG. 4, or may utilize the attribution adjustment value discussed above with reference to FIG. 5. In this example, the model campaign or sub-campaign may be configured to utilize last-touch attribution techniques, as previously discussed.

Method 600 may proceed to operation 606 during which a performance of the plurality of campaigns and/or sub-campaigns as well as the additional campaign or sub-campaign may be measured. Accordingly, the campaigns or sub-campaigns may be implemented over a period of time and performance data may be gathered. Alternatively, the campaigns or sub-campaigns may have been previously implemented, and past performance data may be retrieved. The performance data may identify data events, such as impressions served, as well as actions that have occurred for at least some of the identified campaigns or sub-campaigns. Moreover, in addition to the collection or retrieval or performance data, the appropriate last-touch attribution and multi-touch attribution calculations may be performed. For example, last-touch attribution scores may be calculated for the identified campaigns or sub-campaigns, which include the model. Moreover, multi-dimensional multi-touch attribution scores may be generated for the additional campaign or sub-campaign. In some embodiments, attribution adjustment values may be generated. Further still, a total number of actions may be determined for each campaign or sub-campaign.

Method 600 may proceed to operation 608 during which a result may be determined based on the measured performance. In various embodiments, the performance data and generated scores may be analyzed to determine an improvement that may have been provided by the modification made to the additional campaign or sub-campaign. For example, a first total number of actions may be determined for the plurality of advertisement campaigns and/or sub-campaigns plus an additional number of actions for the model campaign or sub-campaign. Thus, the actions associated with the model campaign or sub-campaign may be counted twice to control for the addition of the additional campaign or sub-campaign in the comparison. A second total number of actions may be determined for the plurality of advertisement campaigns and/or sub-campaigns plus the number of actions generated by the additional campaign or sub-campaign that includes the multi-dimensional multi-touch attribution analysis. If the second total number is greater than the first total number, than it may be determined that the inclusion of the multi-dimensional multi-touch attribution and/or attribution adjustment value increased the total number of actions attributed to the plurality of campaigns and/or sub-campaigns. Moreover, a difference between the first total number and the second total number may quantify the improvement provided.

Method 600 may proceed to operation 610 during which a notification may be generated based on the determined result. Accordingly, a notification or a message capable of being displayed in a display device may be generated. The notification may include the determined results and may provide an entity, such as the advertiser, with a summary of the results. For example, the notification may identify the model campaign or sub-campaign, and may also identify the difference in actions attributed by the transition to the multi-dimensional multi-touch attribution and/or attribution adjustment value that was used. In this way, an advertiser may be provided with a representation of a difference in a determined performance of various campaigns or sub-campaigns, and may configure one or more campaigns or sub-campaigns based on the representation.

FIG. 7A illustrates an example of action attribution, implemented in accordance with some embodiments. As previously discussed, to effectively identify which sub-campaigns and line items are providing the greatest return, an advertiser may determine which sub-campaign contributed to how many user actions, hence quantifying the effectiveness of the different targeting parameters utilized in each sub-campaign. As similarly discussed above, various sequential data structures may be constructed that represent a sequence of data events experienced by a user that may or may not have led to an action. As shown in FIG. 7A, an action or user action, which may be referred to herein interchangeably, may occur long after an advertisement is shown to a user, and there may be many intervening events. For example, a user 702 may see several advertisements online, such as first advertisement 704, second advertisement 706, third advertisement 708, and fourth advertisement 710. User 702 may subsequently perform user action 712, which may be the purchase of an item. In this example, it may be difficult to determine which advertisement caused user action 712, and it may also be difficult to determine to what extent user action 712 should be attributed to a particular advertisement. Accordingly, it may be difficult to attribute user actions to sub-campaigns and reliably determine what return the sub-campaign is providing.

As similarly discussed above, in order to correctly allocate a budget to sub-campaigns, it should be determined how effective each sub-campaign is. Accordingly, it may be desirable to determine how many user actions are attributed to each sub-campaign, as well as how much money was spent on each sub-campaign. The contribution of a sub-campaign may be calculated or determined based on an action attribution method. As previously discussed, one example of a method of attributing a user action to a sub-campaign may be a last-touch attribution method in which the user action is fully attributed to the last event in a sequence of events leading up to the user action. Such sequences of events may be constructed based on available data for each user action. As shown in FIG. 7A, user action 712 may be the purchase of an item, such as an online purchase of a wallet. The sequence of events leading to user action 712 may include the sequential presentation of advertisements 704-710 to user 702. In some embodiments, last-touch attribution may be implemented that attributes user action 712 entirely (100 percent) to the last event in the sequence of events, which may be the last advertisement seen by the user. In the example shown in FIG. 7A, the last event was the display of fourth advertisement 710. Accordingly, last-touch attribution may attribute user action 712 entirely to fourth advertisement 710, and such an attribution or association may be stored as one or more data values in a data storage system.

FIG. 7B illustrates another example of action attribution, implemented in accordance with some embodiments. As discussed above, multi-touch action attribution may attribute a user action to multiple events which may have occurred in a sequence leading up to a user action, such as a series of advertisements seen by a user prior to a purchase. Accordingly, user action 712 may be attributed to some or all events within the sequence of events resulting in the user action instead of just the last event. For example, instead of entirely attributing user action 712 to fourth advertisement 710 in the sequence, multi-touch action attribution may attribute a portion or percentage of the user action to each event in the sequence. Accordingly, first advertisement 704 may be attributed 25% of user action 712, second advertisement 706 may be attributed 25% of user action 712, third advertisement 708 may be attributed 25% of user action 712, and fourth advertisement 710 may be attributed 25% of user action 712. The sum of the partial attributions may add up to 100%. It will be appreciated that while the distribution of the attribution of user action 712 has been described as being equally distributed among advertisements 704-710, the distribution might not be equal and might be weighted based on or more other metrics, as previously discussed above.

As will be appreciated, the methods and attribution numbers described with reference to FIG. 7A and FIG. 7B are merely examples and are in no way intended to limit the embodiments disclosed herein. As previously discussed, line items and sub-campaigns may be referred to interchangeably. Therefore, while FIGS. 7A and 7B make reference to sub-campaigns, the same may apply for line items associated with a campaign.

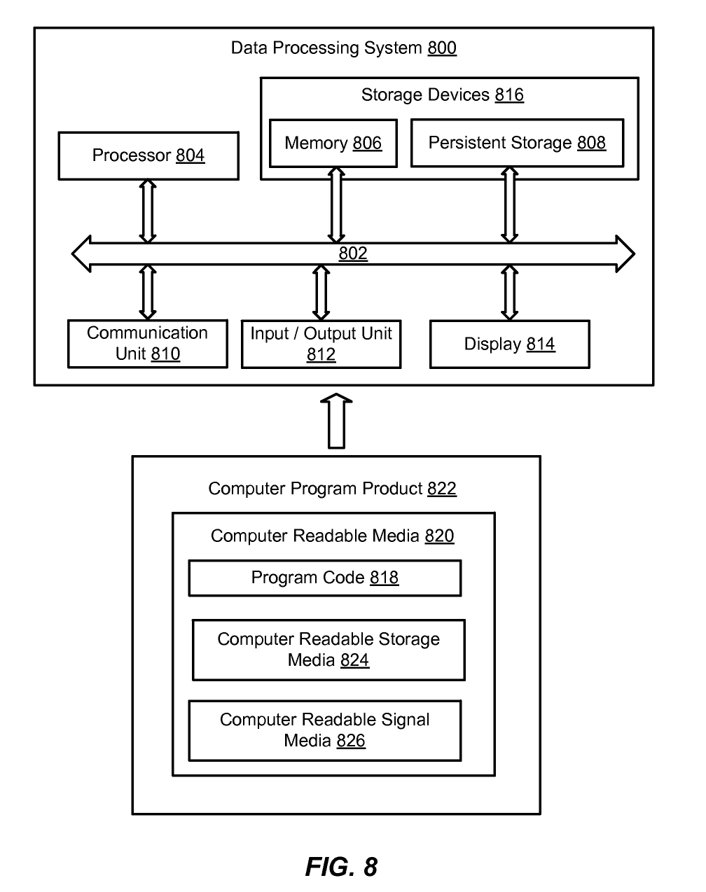

FIG. 8 illustrates a data processing system configured in accordance with some embodiments. Data processing system 800, also referred to herein as a computer system, may be used to implement one or more computers or processing devices used in a controller, server, or other components of systems described above, such as an audience profile model generator. In some embodiments, data processing system 800 includes communications framework 802, which provides communications between processor unit 804, memory 806, persistent storage 808, communications unit 810, input/output (I/O) unit 812, and display 814. In this example, communications framework 802 may take the form of a bus system.

Processor unit 804 serves to execute instructions for software that may be loaded into memory 806. Processor unit 804 may be a number of processors, as may be included in a multi-processor core. In various embodiments, processor unit 804 is specifically configured to process large amounts of data that may be involved when processing reference data and audience profile data associated with one or more advertisement campaigns, as discussed above. Thus, processor unit 804 may be an application specific processor that may be implemented as one or more application specific integrated circuits (ASICs) within a processing system. Such specific configuration of processor unit 804 may provide increased efficiency when processing the large amounts of data involved with the previously described systems, devices, and methods. Moreover, in some embodiments, processor unit 804 may be include one or more reprogrammable logic devices, such as field-programmable gate arrays (FPGAs), that may be programmed or specifically configured to optimally perform the previously described processing operations in the context of large and complex data sets sometimes referred to as “big data.”

Memory 806 and persistent storage 808 are examples of storage devices 816. A storage device is any piece of hardware that is capable of storing information, such as, for example, without limitation, data, program code in functional form, and/or other suitable information either on a temporary basis and/or a permanent basis. Storage devices 816 may also be referred to as computer readable storage devices in these illustrative examples. Memory 806, in these examples, may be, for example, a random access memory or any other suitable volatile or non-volatile storage device. Persistent storage 808 may take various forms, depending on the particular implementation. For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through a keyboard, a mouse, and/or some other suitable input device. Further, input/output unit 812 may send output to a printer. Display 814 provides a mechanism to display information to a user.

Instructions for the operating system, applications, and/or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer usable program code, or computer readable program code that may be read and executed by a processor in processor unit 804. The program code in the different embodiments may be embodied on different physical or computer readable storage media, such as memory 806 or persistent storage 808.

Program code 818 is located in a functional form on computer readable media 820 that is selectively removable and may be loaded onto or transferred to data processing system 800 for execution by processor unit 804. Program code 818 and computer readable media 820 form computer program product 822 in these illustrative examples. In one example, computer readable media 820 may be computer readable storage media 824 or computer readable signal media 826.

In these illustrative examples, computer readable storage media 824 is a physical or tangible storage device used to store program code 818 rather than a medium that propagates or transmits program code 818.

Alternatively, program code 818 may be transferred to data processing system 800 using computer readable signal media 826. Computer readable signal media 826 may be, for example, a propagated data signal containing program code 818. For example, computer readable signal media 826 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 800 are not meant to provide architectural limitations to the manner in which different embodiments may be implemented. The different illustrative embodiments may be implemented in a data processing system including components in addition to and/or in place of those illustrated for data processing system 800. Other components shown in FIG. 8 can be varied from the illustrative examples shown. The different embodiments may be implemented using any hardware device or system capable of running program code 818.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A system comprising:
a sequential data structure generator configured to generate a plurality of sequential data structures based on performance data, the performance data characterizing a plurality of data events associated with a plurality of interactions between at least one user and at least one online advertisement entity, each of the plurality of sequential data structures characterizing a sequential representation of at least some of the plurality of data events during a first time period;
an attribution metric generator configured to generate a first plurality of attribution scores and a first plurality of attribution metrics based on a first plurality of dimensions associated with the plurality of data events included in the plurality of sequential data structures, each of the first plurality of attribution scores identifying a portion of a data event that is attributed to an action, each of the first plurality of attribution metrics identifying a number of actions attributed to the at least one online advertisement entity, and each of the first plurality of attribution metrics being generated based on multiple attribution scores included in each sequential data structure that resulted in an action associated with the at least one online advertisement entity; and
a resource file generator configured to generate a first resource file configured to store one or more data values characterizing the first plurality of attribution metrics, the first resource file being capable of being provided to an advertisement server and being used to generate at least one message including a bid request.

2. The system of claim 1, wherein each of the first plurality of dimensions comprises at least one characteristic of at least one data event.

3. The system of claim 2, wherein each of the first plurality of dimensions is selected from the group consisting of: a biographical identifier, a top level domain identifier, a geographical identifier, a device identifier, a network identifier, an advertisement identifier, an advertiser identifier, and a data category identifier.

4. The system of claim 1, wherein the sequential data structure generator is further configured to generate a second plurality of attribution scores and a second plurality of attribution metrics based, at least in part, on a second plurality of dimensions associated with the plurality of data events.

5. The system of claim 4, wherein the resource file generator is further configured to generate a second resource file configured to store one or more data values characterizing the second plurality of attribution metrics.

6. The system of claim 1, wherein the generating of the first plurality of attribution scores further comprises calculating a plurality of normalized probabilistic weights, the plurality of normalized probabilistic weights being normalized based, at least in part, on the first plurality of dimensions.

7. The system of claim 6, wherein each of the first plurality of attribution metrics is associated with one online advertisement entity and characterizes a probability that a data event associated with the online advertisement entity will result in an action.

8. The system of claim 1, wherein an online advertisement entity is an entity selected from the group consisting of: an online advertisement campaign and an online advertisement sub-campaign.

9. The system of claim 1, wherein the attribution metric generator is further configured to generate a third plurality of attribution scores and a third plurality of attribution metrics based on the plurality of sequential data structures, each of the third plurality of attribution scores identifying a last data event in a sequential data structure that is attributed to an action, each of the third plurality of attribution metrics identifying a number of actions attributed to an online advertisement entity.

10. The system of claim 9, wherein the first resource file is further configured to store one or more data values characterizing the third plurality of attribution metrics.

11. The system of claim 1, wherein a data event is an event selected from the group consisting of: an advertisement view, a page view, and an electronic message, and wherein a user action selected from the group consisting of: a click-through, a purchase, an entry of information in a web-form.

12. A device comprising:
a first processing node configured to generate a plurality of sequential data structures based on performance data, the performance data characterizing a plurality of data events associated with a plurality of interactions between at least one user and at least one online advertisement entity, each of the plurality of sequential data structures characterizing a sequential representation of at least some of the plurality of data events during a first time period;
a second processing node configured to generate a first plurality of attribution scores and a first plurality of attribution metrics based on a first plurality of dimensions associated with the plurality of data events included in the plurality of sequential data structures, each of the first plurality of attribution scores identifying a portion of a data event that is attributed to an action, each of the first plurality of attribution metrics identifying a number of actions attributed to the at least one online advertisement entity, and each of the first plurality of attribution metrics being generated based on multiple attribution scores included in each sequential data structure that resulted in an action associated with the at least one online advertisement entity; and
a third processing node configured to generate a first resource file configured to store one or more data values characterizing the first plurality of attribution metrics, the first resource file being capable of being provided to an advertisement server and being used to generate at least one message including a bid request.

13. The device of claim 12, wherein the first processing node is further configured to generate a second plurality of attribution scores and a second plurality of attribution metrics based, at least in part, on a second plurality of dimensions associated with the plurality of data events, and wherein the third processing node is further configured to generate a second resource file configured to store one or more data values characterizing the second plurality of attribution metrics.

14. The device of claim 12, wherein the generating of the first plurality of attribution scores further comprises calculating a plurality of normalized probabilistic weights, the plurality of normalized probabilistic weights being normalized based, at least in part, on the first plurality of dimensions.

15. The device of claim 14, wherein each of the first plurality of attribution metrics is associated with one online advertisement entity and characterizes a probability that a data event associated with the online advertisement entity will result in an action.

16. The device of claim 12, wherein the second processing node is further configured to generate a third plurality of attribution scores and a third plurality of attribution metrics based on the plurality of sequential data structures, each of the third plurality of attribution scores identifying a last data event in a sequential data structure that is attributed to an action, each of the third plurality of attribution metrics identifying a number of actions attributed to an online advertisement entity.

17. One or more non-transitory computer readable media having instructions stored thereon for performing a method, the method comprising:
generating a plurality of sequential data structures based on performance data, the performance data characterizing a plurality of data events associated with a plurality of interactions between at least one user and at least one online advertisement entity, each of the plurality of sequential data structures characterizing a sequential representation of at least some of the plurality of data events during a first time period;
generating a first plurality of attribution scores based, at least in part, on a first plurality of dimensions associated with the plurality of data events included in the plurality of sequential data structures, each attribution score identifying a portion of a data event that is attributed to an action;
generating a first plurality of attribution metrics based, at least in part, on the first plurality of dimensions associated with plurality of data events included in the plurality of sequential data structures and based on the first plurality of attribution scores, each of the first plurality of attribution metrics identifying a number of actions attributed to an online advertisement entity, and each of the first plurality of attribution metrics being generated based on multiple attribution scores included in each sequential data structure that resulted in an action associated with the at least one online advertisement entity; and
generating a first resource file configured to store one or more data values characterizing the first plurality of attribution metrics, the first resource file being capable of being provided to an advertisement server and being used to generate at least one message including a bid request.

18. The one or more non-transitory computer readable media of claim 17, wherein the method further comprises:
generating a second plurality of attribution scores and a second plurality of attribution metrics based, at least in part, on a second plurality of dimensions associated with the plurality of data events; and
generating a second resource file configured to store one or more data values characterizing the second plurality of attribution metrics.

19. The one or more non-transitory computer readable media of claim 17, wherein the generating of the first plurality of attribution scores further comprises calculating a plurality of normalized probabilistic weights, the plurality of normalized probabilistic weights being normalized based, at least in part, on the first plurality of dimensions.

20. The one or more non-transitory computer readable media of claim 17, wherein the method further comprises:
generating a third plurality of attribution scores and a third plurality of attribution metrics based on the plurality of sequential data structures, each of the third plurality of attribution scores identifying a last data event in a sequential data structure that is attributed to an action, each of the third plurality of attribution metrics identifying a number of actions attributed to an online advertisement entity.
